(19) United States
(12) Patent Application Publication
(10) Pub. No.: US 2021/0175794 A1
(43) Pub. Date: Jun. 10, 2021

(54) SNUBBER CIRCUIT FOR REDUCING POWER CONSUMPTION OF FLYBACK CONVERTER

(71) Applicant: SHIH-CHAO LI, Kaohsiung City (TW)

(72) Inventor: Chin-Wen SHANG, Kaohsiung City (TW)

(73) Assignee: SHIH-CHAO LI, Kaohsiung City (TW)

(21) Appl. No.: 17/094,194

(22) Filed: Nov. 10, 2020

(30) Foreign Application Priority Data
Dec. 4, 2019 (TW) 108144318

(51) Int. Cl. H02M 1/34; H02M 3/335

(52) U.S. Cl. CPC H02M 1/34; H02M 2001/348; H02M 3/33523

(57) ABSTRACT

A snubber circuit for reducing power consumption of a flyback converter is provided in a flyback circuit and has an absorption circuit and a damping diode connected in series to the absorption circuit. The absorption circuit includes a clamping diode, a damping capacitor with one end thereof connected to the cathode of the clamping diode, and a damping resistor with one end thereof connected to another end of the damping capacitor and another end thereof connected to the anode of the clamping diode. The power source and the primary side of the transformer are electrically connected with the absorption circuit, the damping diode, and the clamping circuit that are connected in series. When the clamping diode is turned off, because the energy absorbed by the damping capacitor is provided by the clamping circuit, no additional power is consumed and electromagnetic noises are filtered.

### BACKGROUND OF THE INVENTION

### 1. Field of the Invention

The invention relates to a snubber circuit and, in particular, to a snubber circuit capable of reducing power consumption of a flyback converter.

### 2. Description of Related Art

Please refer to FIG. 7 for a conventional flyback circuit. As shown in the drawing, the conventional flyback circuit consists of a power source Vin, a transformer T2, a flyback diode Do, a flyback capacitor Co, a flyback resistor Ro, and a magnetizing inductor Lm. The power source Vin is connected to the primary side of the transformer T2. The other end of the transformer T2 is connected to a switch Q2. The anode of the flyback diode Do is connected to the secondary side of the transformer T2. The flyback capacitor Co and the flyback resistor Ro are connected in parallel. The flyback capacitor Co is connected to the cathode of the flyback diode Do. The magnetizing inductor Lm is connected in parallel with the transformer T2.

Generally, the flyback circuit has a leakage inductor Lₗₖ due to the non-ideal matching of the transformer T2, such that the switch Q2 may be damaged due to the high voltage generated by an instantaneous current change. In order to overcome the influence of the leakage inductor Lₗₖ on the switch Q2, an RCD clamping circuit formed by a clamping resistor Rc, a clamping capacitor Cc, and a clamping diode Dc, as shown in the figure, is often used to protect the switch Q2 from being damaged by an excessively high voltage. At the same time, an RC snubber circuit is connected in parallel to the switch Q2. The RC snubber circuit includes a snubber capacitor Cs and a snubber resistor Rs connected in series with each other. The RC snubber circuit reduces electromagnetic interference (EMI) noises.

However, in such a flyback circuit, the power consumption of the RC snubber circuit is proportional to the square of the power source voltage Vin. When the flyback circuit operates at a higher voltage Vin, the RC snubber circuit consumes a larger amount of power, increasing the usage cost and generating a huge amount of heat. It is then imperative to consider the problems of higher power consumption and larger heat production when conventional flyback circuits are operating at a high voltage Vin.

Please refer to FIG. 8 for another conventional flyback circuit. The difference from the previous flyback circuit is that the position of the RCD clamping circuit is replaced by a clamping diode Dc. The clamping capacitor Cc is connected between the clamping diode Dc and the magnetizing inductor Lm and the leakage inductor Lₗₖ. The anode and ground of the clamping diode Dc are connected in series with an energy recycle diode Der and an energy recycle inductance Ler.

Similarly, in order to reduce the noise of electromagnetic interference in this flyback circuit, an RC snubber circuit is often used to eliminate the electromagnetic noises. But it will also cause an increase in power consumption. In the state of high voltage Vin applications, there will also be problems of higher power consumption and heat dissipation.

### SUMMARY OF THE INVENTION

In order to solve the problem of high power consumption in the current flyback circuit, the invention proposes a snubber circuit for reducing the power consumption of the flyback converter. By connecting a clamping circuit in parallel with an absorption circuit, the invention can maintain the function of filtering out electromagnetic interference noise and also reduce the power consumption caused by the clamping circuit.

To achieve the above-mentioned objective, the invention proposes a snubber circuit for reducing power consumption of a flyback converter. The snubber circuit is provided in a flyback circuit, which includes a power source, a transformer, a flyback diode, and a flyback capacitor. A primary side of the transformer is connected in parallel with a magnetizing inductor. One end of the transformer is connected to the power source. Another end of the transformer is electrically connected to a switch after a leakage inductor is connected in series. The snubber circuit is further electrically connected to a clamping circuit. The disclosed snubber circuit that reduces the power consumption of the flyback converter comprises:
an absorption circuit, including:
   a clamping diode having a cathode and an anode;
   a damping capacitor, with one end thereof electrically connected to the cathode of the clamping diode; and
   a damping resistor, with one end thereof electrically connected to another end of the damping capacitor and another end of the damping resistor electrically connected to the anode of the clamping diode; and
a damping diode connected in series with the absorption circuit and having a cathode and an anode;
wherein the power source and the primary side of the transformer are electrically connected to the absorption circuit, the damping diode and the clamping circuit that are connected in series.

The invention further provides another snubber circuit for reducing the power consumption of a flyback converter. The snubber circuit is provided in a flyback circuit, which includes a power source, a transformer, a flyback diode, and a flyback capacitor. The primary side of the transformer is connected in parallel with a magnetizing inductor. One end of the transformer is connected to the power source, and another end thereof is electrically connected to a switch after a leakage inductor is connected in series. The leakage inductor is electrically connected with one end of a clamping capacitor, and another end of the clamping capacitor is connected to an energy recycle diode and an energy recycle inductor connected in series with each other. The energy recycle diode and the energy recycle inductor are connected in series to ground. The snubber circuit for reducing the power consumption of flyback converter includes:
an absorption circuit, including:
   a clamping diode having a cathode and an anode;
   a damping capacitor, with one end thereof electrically connected to the cathode of the clamping diode; and
   a damping resistor, with one end thereof electrically connected to another end of the damping capacitor, and the other end thereof electrically connected to the anode of the clamping diode; and
a damping diode connected in series with the absorption circuit;
wherein the power source and the primary side of the transformer are electrically connected to the absorption circuit and the damping diode connected in series with each other.

The damping capacitor is connected in parallel with the damping resistor to form the circuit of the invention, and can be used to filter out electromagnetic noises of the switch when applied to a flyback circuit. The disclosed circuit does not increase the power consumption of the entire circuit due to the voltage increase in the flyback circuit, and maintains the same power consumption as the circuit without using the invention.

### BRIEF DESCRIPTION OF THE DRAWINGS

FIG. 1 is a circuit diagram according to a first preferred embodiment of the invention;

FIG. 2 shows a waveform diagram of the application of the invention;

FIG. 3 is a circuit diagram according to a second preferred embodiment of the invention;

FIG. 4 is a circuit diagram according to a third preferred embodiment of the invention;

FIG. 5 is a circuit diagram according to a fourth preferred embodiment of the invention;

FIG. 6 is a circuit diagram according to a fifth preferred embodiment of the invention;

FIG. 7 shows the architecture of a conventional flyback circuit that can filter out electromagnetic interference noises; and

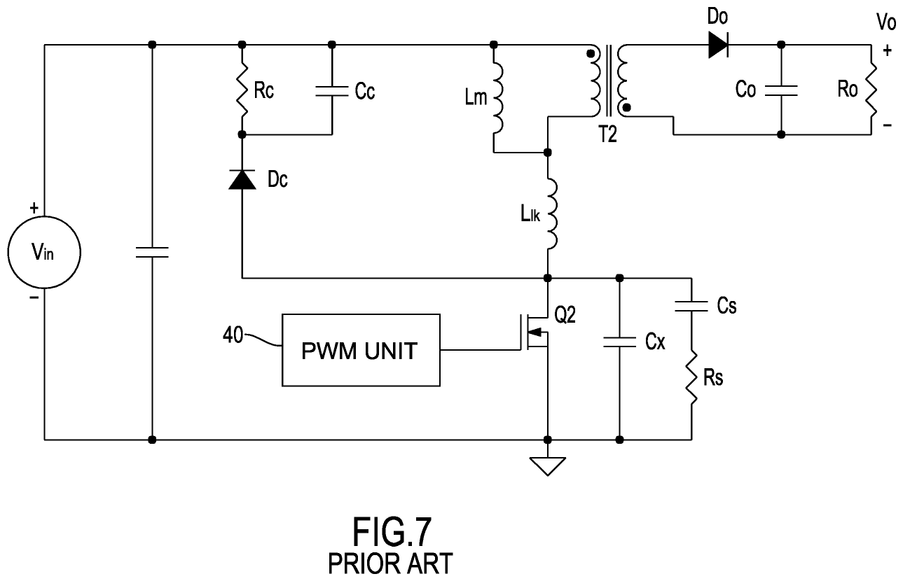

FIG. 8 shows the architecture of another conventional flyback circuit that can filter out electromagnetic interference noises.

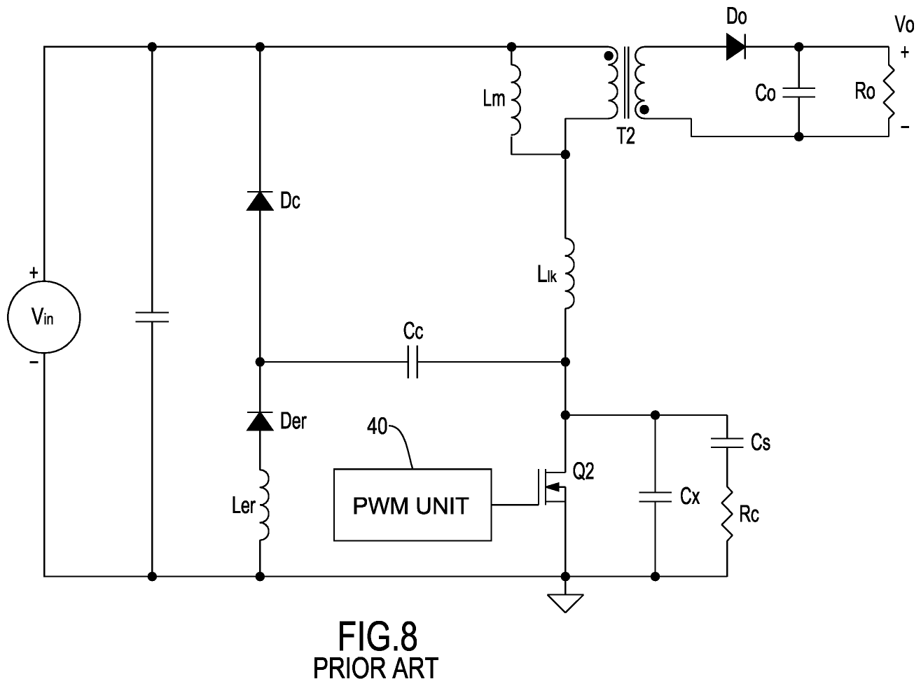

### DETAILED DESCRIPTION OF THE PREFERRED EMBODIMENT

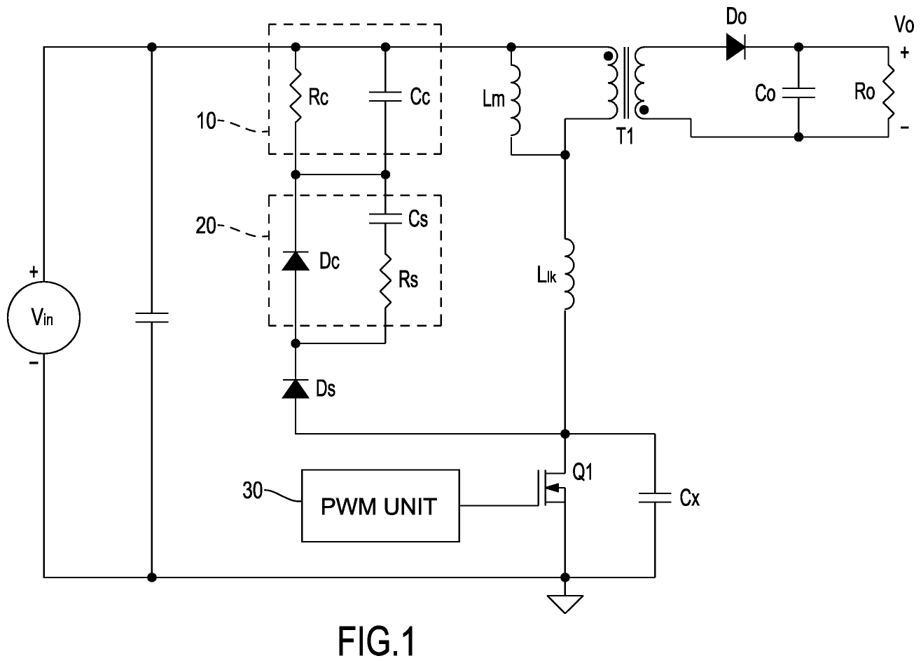

Please refer to FIG. 1. The invention provides a snubber circuit for reducing power consumption of a flyback converter used in a flyback circuit. The flyback circuit may include a power source Vin, a transformer T1, a flyback diode Do, a flyback capacitor Co, and a clamping circuit 10. A magnetizing inductor Lm is connected in parallel on the primary side of the transformer T1. One end of the transformer T1 is connected to the power source Vin and the clamping circuit 10, and another end thereof is electrically connected to a switch Q1 after a leakage inductor Lₗₖ is connected in series. The switch Q1 is connected in parallel with a parasitic capacitor Cx. In a preferred embodiment of the invention, the switch Q1 is a field effect transistor, and the leakage inductor Lₗₖ is connected in series with the drain (D) of the field effect transistor. The gate (G) of the field effect transistor can be connected to a pulse width modulation control (PWM) unit 30, and the emitter (S) of the field effect transistor is grounded.

The anode of the flyback diode Do is connected to the secondary side of the transformer T1, and the cathode thereof is connected to one end of the flyback capacitor Co. The flyback capacitor Co can be further connected in parallel with a load resistor Ro.

The clamping circuit 10 may include a clamping resistor Rc and a clamping capacitor Cc connected in parallel with each other.

The snubber circuit for reducing power consumption of the flyback converter (hereinafter referred to as the snubber circuit) includes a damping diode Ds and an absorption circuit 20. The absorption circuit 20 is connected in series with the clamping circuit 10 and the damping diode Ds, and includes the following components: a clamped diode Dc, a damping capacitor Cs, and a damping resistor Rs. In a first preferred embodiment of the invention, the damping capacitor Cs is connected in series with the damping resistor Rs and then connected in parallel with the clamping diode Dc. The cathode of the clamping diode Dc is connected to the clamping resistor Rc and the clamping capacitor Cc. The absorption circuit 20 is further connected in series with the damping diode Ds and electrically connected to the drain of the field effect transistor.

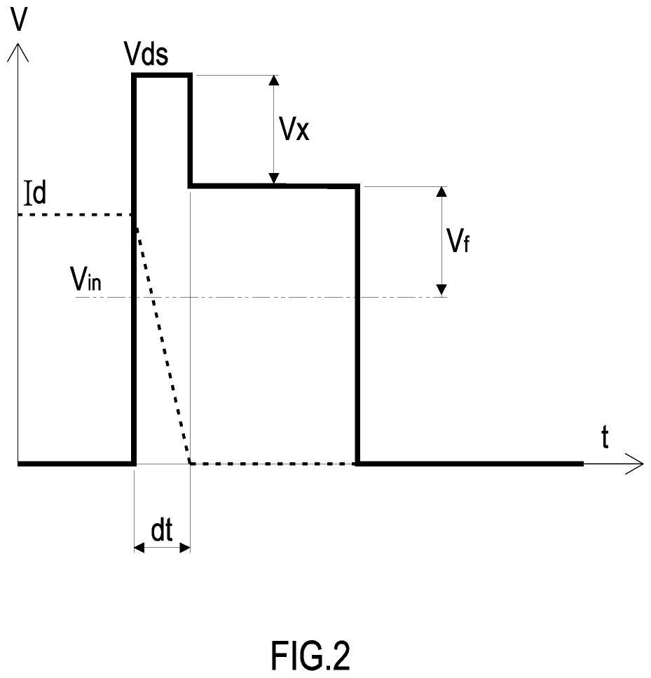

Please refer to FIG. 2. First, the operation of the flyback circuit is as follows. When the switch Q1 is turned on, the flyback circuit stores energy in the transformer T1. When the switch Q1 is turned off, the current flowing through the leakage inductor Lₗₖ is Ipk. Afterwards, the flyback diode Do is turned on to output energy to the flyback capacitor Co.

At this time, there is a reflected voltage V_{f} on the primary side of the transformer T1. The drain voltage V_{ds} of the switch Q1 reaches Vᵢₙ+V_{f}. The leakage inductor Lₗₖ charges the clamping capacitor Cc through the damping diode Ds and the clamping diode Dc at the charging voltage of V_{f}+Vx. Generally, the appropriate clamping capacitor Cc is chosen so that Vᵢₙ+V_{f}+Vx is smaller than V_{DSS} to protect the switch. Moreover, the clamping resistor Rc is properly chosen so that the energy on the clamping capacitor Cc is completely consumed.

In the following, we describe how the snubber circuit operates. The reverse recovery time (Tᵣᵣ) of the damping diode Ds needs to be greater than the reverse recovery time (Tᵣᵣ) of the clamped diode Dc so that there is sufficient time to absorb the energy of the stray element (parasitic element). In the disclosed circuit, when the switch Q1 is turned off, the secondary side of the transformer T1 discharges. The flyback diode Do is turned on, so that the voltage across the transformer T1 is V₁+V_{f} plus the voltage across the flyback diode Do. The voltage of the leakage inductor L_{lK} rises and charges the clamping capacitor Cc. At this moment, the clamping diode Dc and the damping diode Ds is turned on, and the clamping circuit 10 starts to operate. As the reverse recovery time of the damping diode Ds has to be longer than the reverse recovery time of the clamping diode Dc, the clamping diode Dc is turned off first, and then the snubber circuit starts to operate. Next, the energy stored in the damping capacitor Cs in the previous cycle is consumed by the damping resistor Rs when the clamping diode Dc is turned on. When the clamping diode Dc is turned off, the damping diode Ds is still on. The damping capacitor Cs completely absorbs the energy of the parasitic capacitor Cx and the leakage inductor Lₗₖ, and the clamping capacitor Cc charges the damping capacitor Cs, so that the damping capacitor Cs absorbs energy from the clamping capacitor Cc. Since the energy absorbed by the damping capacitor Cs is provided by the clamping capacitor Cc, the energy absorbed and released by the clamping capacitor Cc and the clamping resistor Rc is the same as that of the conventional clamping circuit. Therefore, the damping resistors Rs and the damping capacitor Cs do not consume additional energy.

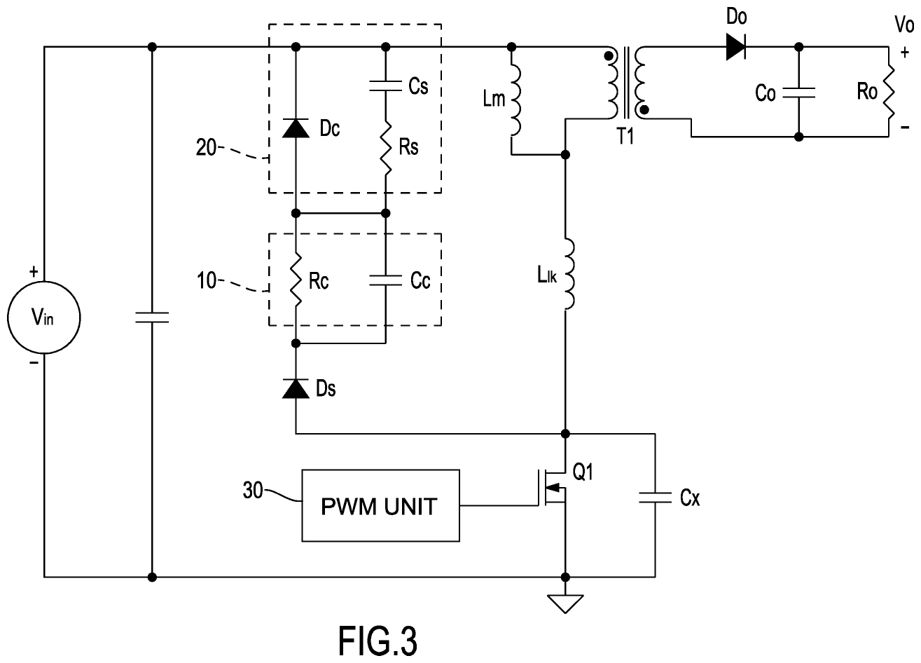

Please refer to FIG. 3. In a second preferred embodiment of the invention, the difference from the first embodiment lies in that the anode of the clamping diode Dc is connected to one end of the clamping resistor Rc and the clamping capacitor Cc. Another end of the clamping resistor Rc and another end of the clamping capacitor Cc are further electrically connected to the cathode of the damping diode Ds.

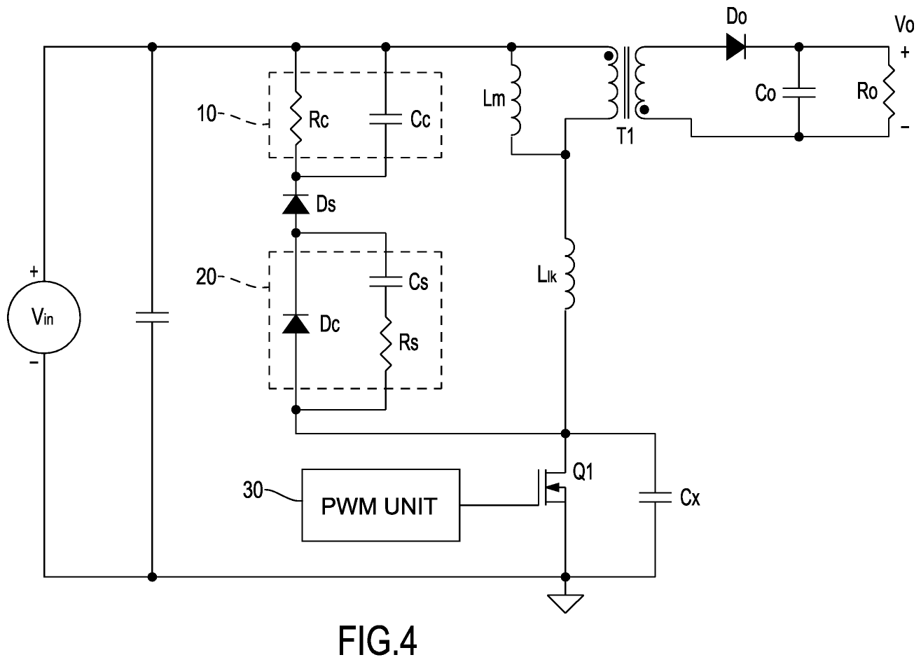

Please refer to FIG. 4. In a third preferred embodiment of the invention, the difference from the first embodiment is that the absorption circuit 20 is electrically connected to the clamping circuit 10 connected through the damping diode Ds. The anode of the damping diode Ds is electrically connected to the cathode of the clamping diode Dc, and the cathode of the damping diode Ds is electrically connected to the clamping circuit 10.

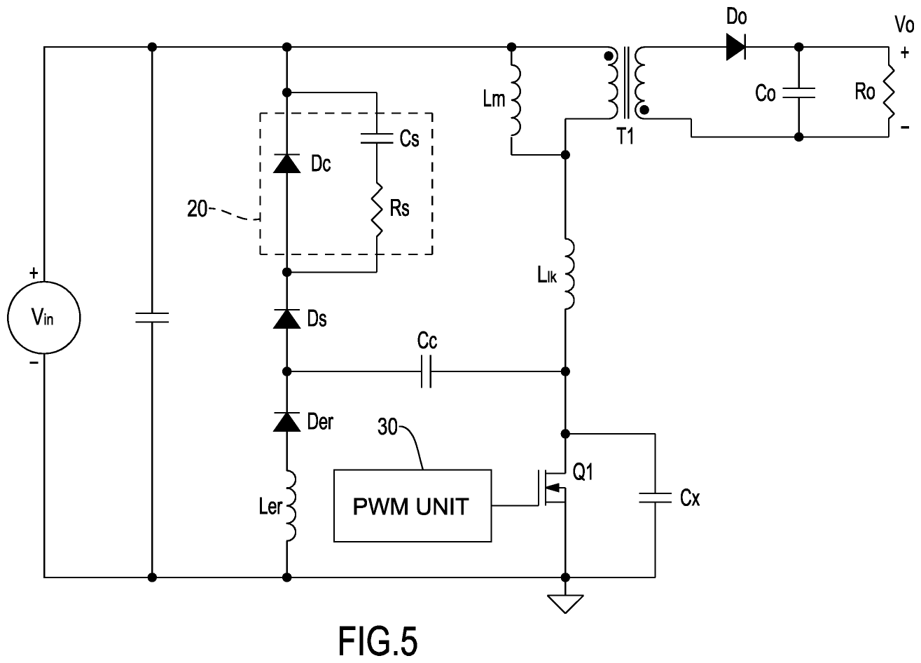

Please refer to FIG. 5. In a fourth preferred embodiment of the invention, the difference from the first embodiment is that the disclosed circuit replaces the clamping circuit 10, so that the absorption circuit 20 is connected in series with the damping diode Ds. The cathode of the clamping diode Dc is electrically connected to the anode of the power source Vin and the primary side of the transformer T1. The anode of the clamping diode Dc is electrically connected to the cathode of the damping diode Ds. The anode of the damping diode Ds is electrically connected to the clamping capacitor Cc and an energy recycle diode Der and an energy recycle inductor Ler connected in series with each other. This embodiment can also achieve the function of filtering electromagnetic interference without requiring additional power consumption.

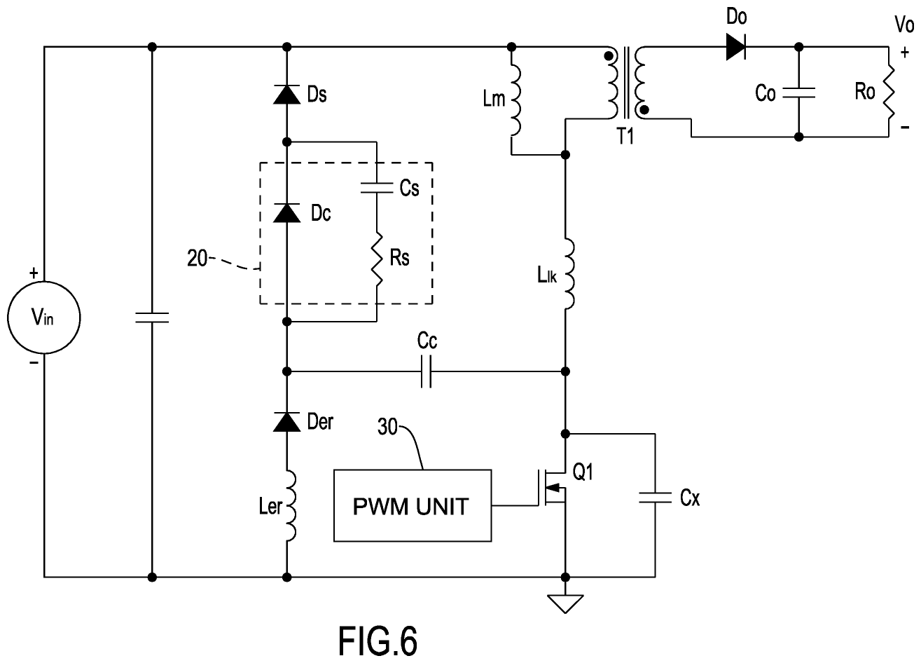

Referring to FIG. 6 for a fifth preferred embodiment of the invention. This embodiment differs from the fourth embodiment in that the anode of the damping diode Ds is electrically connected to the cathode of the clamping diode Dc, and is electrically connected to another end of the damping capacitor Cs. The cathode of the damping diode Ds is electrically connected to the anode of the power source Vin and the primary side of the transformer T1.

As can be seen from the above description and drawings, the absorption circuit 20 of the invention can arbitrarily adjust its connection relationship with the damping diode Ds and the clamping circuit 10 in the flyback circuit. While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A snubber circuit for reducing power consumption of a flyback converter disposed in a flyback circuit that includes a power source, a transformer, a flyback diode, and a flyback capacitor, with a primary side of the transformer connected in parallel with a magnetizing inductor, one end of the transformer connected to the power source, and another end of the transformer connected to a leakage inductor in series and then connected to a switch;
the snubber circuit being further electrically connected to a clamping circuit and comprising:
an absorption circuit including:
a clamping diode having a cathode and an anode;
a damping capacitor, with one end thereof electrically connected to the cathode of the clamping diode; and
a damping resistor, with one end thereof electrically connected to another end of the damping capacitor and another end of the damping resistor electrically connected to the anode of the clamping diode; and
a damping diode connected in series with the absorption circuit;
wherein the power source and the primary side of the transformer are electrically connected to the absorption circuit, the damping diode and the clamping circuit that are connected in series.

2. The snubber circuit as claimed in claim 1, wherein the clamping circuit includes a clamping resistor and a clamping capacitor connected in parallel, with the cathode of the clamping diode connected to one end of the clamping resistor and one end of the clamping capacitor, and with the anode of the clamping diode electrically connected to the cathode of the damping diode.

3. The snubber circuit as claimed in claim 1, wherein the clamping circuit includes a clamping resistor and a clamping capacitor connected in parallel, with the anode of the clamping diode connected to one end of the clamping resistor and one end of the clamping capacitor, and another end of the clamping resistor and another end of the clamping capacitor electrically connected to the cathode of the damping diode.

4. The snubber circuit as claimed in claim 1, wherein the absorption circuit is electrically connected to the clamping circuit through the damping diode;
the clamping circuit includes a clamping resistor and a clamping capacitor connected in parallel;
the cathode of the damping diode is electrically connected to one end of the clamping resistor and one end of the clamping capacitor;
the anode of the damping diode is electrically connected to the cathode of the clamping diode; and
another end of the clamping resistor and another end of the clamping capacitor are electrically connected to the power source and the primary side of the transformer.

5. A snubber circuit for reducing power consumption of a flyback converter disposed in a flyback circuit that includes a power source, a transformer, a flyback diode, and a flyback capacitor, with a primary side of the transformer connected in parallel with a magnetizing inductor, one end of the transformer connected to the power source, and another end of the transformer electrically connected to a leakage inductor in series and then connected to a switch, the leakage inductor electrically connected with one end of a clamping capacitor, another end of the clamping capacitor connected to an energy recycle diode and an energy recycle inductor connected in series, wherein the energy recycle diode and the energy recycle inductor connected in series are grounded; the snubber circuit comprising:
an absorption circuit including:
a clamping diode having a cathode and an anode;
a damping capacitor, with one end thereof electrically connected to the cathode of the clamping diode; and
a damping resistor, with one end thereof electrically connected to another end of the damping capacitor and another end of the damping resistor electrically connected to the anode of the clamping diode; and
a damping diode connected in series with the absorption circuit and having a cathode and an anode;
wherein the power source and the primary side of the transformer are electrically connected to the absorption circuit, the damping diode and the clamping circuit that are connected in series.

6. The snubber circuit as claimed in claim 5, wherein the cathode of the damping diode is electrically connected to the anode of the clamping diode, and the anode of the damping diode is electrically connected to the cathode of the energy recycle diode.

7. The snubber circuit as claimed in claim 5, wherein the anode of the damping diode is electrically connected to the cathode of the clamping diode and another end of the damping capacitor;
the cathode of the damping diode is electrically connected to the power source and the primary side of the transformer; and
the anode of the clamping diode is electrically connected to a cathode of the energy recycle diode.
